(19) United States
(12) Patent Application Publication
(10) Pub. No.: US 2025/0136432 A1
(43) Pub. Date: May 1, 2025

(54) TRANSFER SYSTEM, UNIT AND METHOD FOR ROAD CONSTRUCTION FLUIDS

(71) Applicant: Idaho Asphalt Supply, Inc., Idaho Falls, ID (US)

(72) Inventors: Douglas Ray OLSEN, Reno, NV (US); Kim Walker, Idaho Falls, ID (US); Corey Shurtliff, Shelley, ID (US); Huachun ZHAI, Boise, ID (US)

(73) Assignee: Idaho Asphalt Supply, Inc., Idaho Falls, ID (US)

(21) Appl. No.: 18/919,713

(22) Filed: Oct. 18, 2024

Related U.S. Application Data
(60) Provisional application No. 63/594,539, filed on Oct. 31, 2023.

(51) Int. Cl. B67D 7/76; B67D 7/02; B67D 7/38; B67D 7/58; E01C 19/18

(52) U.S. Cl. CPC B67D 7/76; B67D 7/0294; B67D 7/38; B67D 7/58; E01C 19/18

(57) ABSTRACT

A unit is disclosed for use in transferring fluids between two or more locations. The fluid transfer unit may include a body having a first end and an opposing second end, an inlet fitting connected to the first end of the body, and an outlet fitting connected to the second end of the body. The fluid transfer unit may also include a screen disposed inside the body between the inlet and outlet fittings, and at least one seal disposed at an end of the screen and configured to retain the screen at a desired location inside the body during transportation of the fluid transfer unit.

### RELATED APPLICATIONS

This application is based on and claims the benefit of priority from U.S. Provisional Application No. 63/594,539 that was filed on Oct. 31, 2023, the contents of which are expressly incorporated herein by reference.

### TECHNICAL FIELD

The present disclosure relates generally to a transfer system and unit, and more particularly, to a system and unit for use in transferring road construction fluids.

### BACKGROUND

For the purposes of this disclosure, a road can be considered a durable surface (e.g., a route, way, path, drive, street, lane, lot, or similar thoroughfare or park) that has been prepared on land or over water to support any one or more of various types of traffic (e.g., vehicular traffic, pedestrian traffic, railway traffic, aircraft ground traffic, bicycle traffic, etc.). While roads can be constructed in a variety of different ways, most of these ways involve the application of a specialized material to an existing or newly prepared surface.

Asphalt is one example of a material specially prepared for use in building roads. Asphalt, also known as bitumen, is a liquid binder used to adhere filler or reinforcement (e.g., sand, aggregate, etc.) together and to the underlying surface. An asphalt road is durable and flexible, allowing expansion and contraction without significant damage. The asphalt can be asphalt cement (AC), polymer modified asphalt (PMA), cutback, or an emulsion. Other materials (e.g., primers, hardeners, additives, etc.) may be used together with asphalt when constructing roads.

During construction of a road, asphalt is often applied by a distributor truck having a tank that holds a finite volume of the material. Depending on a size or length of the road, the distributor truck may need to dispense multiple tank volumes of asphalt before construction is complete. The distributor truck can be refilled on-site with asphalt and/or other road construction fluids from a larger tanker truck.

A typical refill procedure involves connecting (e.g., via a camlock coupler) a hose from an outlet of the larger tanker truck to an inlet of a pump mounted on the distributor truck. A valve on the tanker truck is then opened, and the pump is activated to pump asphalt from the tanker truck into the distributor truck.

Although the typical fluid refill procedure may be successful in some applications, it can also be problematic. For example, it may be possible for the liquids in the tanker truck to be contaminated, to cool and thicken, and/or to breakdown into viscous globs or solid chunks. If left unchecked, these globs/chunks can contaminate components (e.g., the pump, valves, spray bars, nozzles, heaters, conduits, etc.) of the distributor truck, causing poor operation, blockages, and/or malfunctions. In addition, the globs/chunks may not meet requirements specified by a contractor or government entity responsible for the road. In some cases, the globs/chunks could even cause the road to perform poorly or fail.

In some situations, a screen box is used to strain out undesirables during the transfer of asphalt from the tanker truck to the distributor truck. A typical screen box includes a metallic body cast in a cuboid shape and having an open top. A cuboid screen is placed into the box, and the open top is closed off with a lid using multiple camlock latches. Hoses from the tanker truck and the distributor truck are connected (e.g., via threaded fasteners and/or pipe threading of hose ends) to opposing sides of the cuboid body, and asphalt flowing from the tanker truck to the distributor truck passes through the screen for removal of the globs and chunks. An example screen box made by the BearCat Pump Company and available commercially in sizes ranging from 1.5-6″ can be viewed at https://www.bearcatpumps.com/pages/asphaltScreenBox.html.

Although screen boxes may be functionally adequate at removing globs and chunks from asphalt during a fluid transfer, they are less than optimal. For example, they are bulky, heavy, difficult to move around a job site, hard to clean, and expensive. In addition, screen boxes can be messy and contaminate the environment when the screen becomes clogged and must be replaced. For example, even after turning off the valve at the tanker truck, the hoses are still full of asphalt that spills through the open body when the lid is removed or the hoses are disconnected from the body.

The disclosed transfer system, unit, and method are directed to overcoming one or more of the problems set forth above and/or other problems of the prior art.

### SUMMARY

In one aspect, the present disclosure is directed to a fluid transfer unit. The fluid transfer unit may include a body having a first end and an opposing second end, an inlet fitting connected to the first end of the body, and an outlet fitting connected to the second end of the body. The fluid transfer unit may also include a screen disposed inside the body between the inlet and outlet fittings, and at least one seal disposed at an end of the screen and configured to retain the screen at a desired location inside the body during transportation of the fluid transfer unit.

In another aspect, the present disclosure is directed to another fluid transfer unit. This fluid transfer unit may include a generally cylindrical body having a first end and an opposing second end, an inlet fitting connected to the first end of the cylindrical body, and an outlet fitting connected to the second end of the cylindrical body. The fluid transfer unit may also include a conical or frustoconical screen disposed inside the cylindrical body.

In another aspect, the present disclosure is directed to a fluid transfer system. The fluid transfer system may include a body having a first end and an opposing second end, an inlet fitting connected to the first end of the body, and an outlet fitting connected to the second end of the body. The fluid transfer system may also include a disposable screen locatable inside the body between the inlet and outlet fittings, and a non-disposable screen interchangeable with the disposable screen. The disposable screen may have perforations with a standard opening size of 6-20, and the non-disposable screen may have perforations with a standard opening size of 10-200.

### BRIEF DESCRIPTION OF THE DRAWINGS

FIG. 1 is a diagrammatic illustration of an example transfer system that may be used with road building machines;

FIG. 2 is a pictorial illustration of an example transfer unit that may form a portion of the transfer system of FIG. 1;

FIG. 3 is an exploded view illustrations of the example transfer unit of FIG. 2;

FIG. 4 is a pictorial illustration of an alternative portion of the transfer unit of FIG. 2;

FIG. 5 is an exploded view illustration of another example of a transfer unit that may form a portion of the transfer system of FIG. 1;

FIG. 6 is an isometric illustration of example valve that may be used in conjunction with the transfer units of FIGS. 1, 2, 3, and/or 5; and

FIG. 7 is a cross-sectional illustration of another example of a transfer unit that may form a portion of the transfer system of FIG. 1.

### DETAILED DESCRIPTION

The terms “about” and/or “generally” as used herein serve to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1%, of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

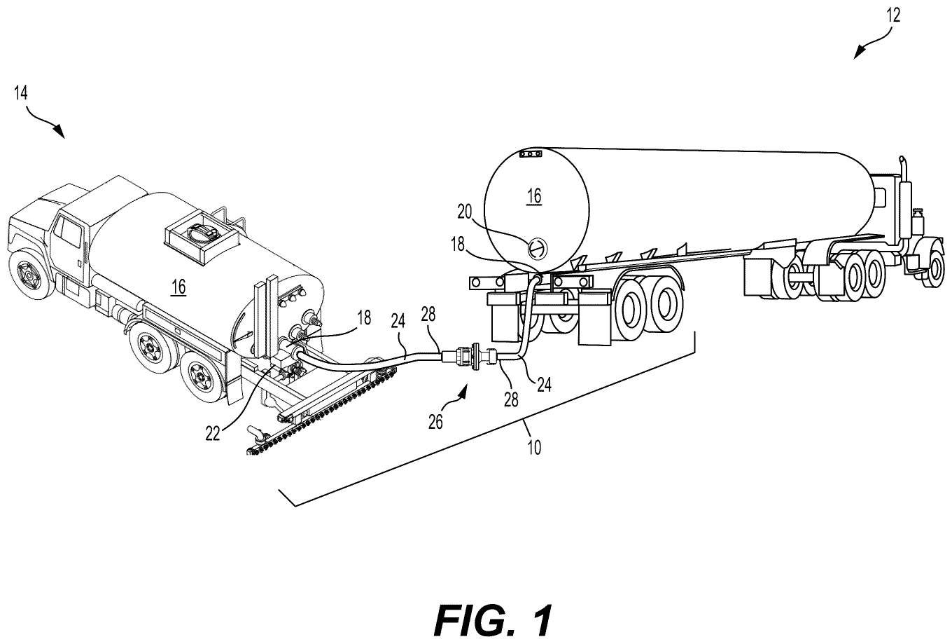

FIG. 1 illustrates a fluid transfer system (“system”) 10 used in the road-construction industry to transfer road construction fluids (e.g., asphalt, tar, primers, hardeners, etc.) between two or more locations. In the disclosed embodiment, system 10 is being used to transfer hot liquid asphalt between a tanker truck 12 and a distributor truck 14. In this configuration, tanker truck 12 is the fluid provider, while distributor truck 14 is the fluid receiver. It is contemplated, however, that the flow of asphalt within system 10 could be reversed (e.g., to flow from distributor truck 14 into tanker truck 12), if desired. It is further contemplated that one or more of the trucks could alternatively be replaced with a non-motorized vehicle (e.g., a trailer or a railcar) or a stationary receptacle (e.g., at a storage facility).

System 10 may include, among other things, at least two fluid tanks 16 (e.g., one tank 16 associated with each of the trucks, trailer, railcar, or storage facility) each having at least one port 18 (e.g., an outlet port associated with the supplying tank 16, and an inlet port associated with the receiving tank 16). In some embodiments, tank 16 may include a single port 18 that functions as both inlet and outlet, depending on the situation. In other embodiments, tank 16 includes a dedicated inlet port 18 and a dedicated outlet port 18. It is contemplated that additional ports (e.g., vent ports, cleaning ports, sampling ports, etc. may also be included as part of each tank 16.

Generally, the supplying tank 16 is volumetrically larger than the receiving tank 16. For example, tank 16 of tanker truck 12 may hold about 5,000-12,000 gallons of road construction fluid, while tank 16 of distributor truck 14 may hold about 1,000-3,000 gallons. It should be noted, however, that this volumetric relationship could be reversed or that the volumes may be substantially identical, if desired. In some embodiments, tank 16 may include internal dividers that baffle oscillations during travel over uneven ground. Each tank 16 may be fabricated from a material suitable for holding the road-building fluid in a secure manner. In some embodiments, the material is non-corrosive, such as PVC, aluminum, stainless steel, or a composite material.

Port 18 may be fluidly connected with an internal cavity of tank 16. In some embodiments (e.g., when port 18 is a dedicated outlet port), port 18 may be connected with a gravitationally lowest portion of tank 16, such that the fluid therein may drain completely from the supplying tank 16 without requiring a pump. In other embodiments (e.g., when port 18 is a dedicated inlet port), port 18 may be located at a gravitationally highest portion of tank 16. Regardless of the location, a valve 20 may be associated with one or both of inlet or outlet ports 18. It should be noted that, while only a single valve 20 is shown in FIG. 1 as being associated with only tanker truck 12, an additional valve 20 could be associated with distributor truck 14, if desired.

Although gravity may assist in transferring fluid from tanker truck 12 to distributor truck 14, a pump 22 may additionally or alternatively be provided as part of system 10 and mounted to either truck 12, 14. In the disclosed embodiment, pump 22 is mounted to distributor truck 14 in fluid communication with inlet port 18. It should be noted that pump 22 could alternatively be mounted to tanker truck 14 or at a location between trucks 12, 14 (e.g., not mounted directly to cither truck).

System 10 may additionally include one or more conduits 24 and a transfer unit 26. In the disclosed embodiment, two conduits 24 are shown, each extending from the associated truck 12, 14 to connect with opposing ends of transfer unit 26. It is contemplated, however, that either one of the conduits 24 could be omitted, if desired. In this situation, the end of transfer unit 26 opposite the remaining conduit 24 may be connected directly to the free port 18 (and/or pump 22). It is also contemplated that, in the dual-conduit embodiment shown in FIG. 1, pump 22 could be located between conduits 24 (e.g., immediately adjacent one end or the other of transfer unit 26).

Each conduit 24 may be a rubber strip-wound hose or a metallic (e.g., stainless steel) corrugated hose that is flexible, weather resistant, and suitable for high temperatures. The metallic corrugated hose may be more suitable for higher-temperature applications, as it may be more resistant to heat and/or maintain its shape/size/rigidity more closely under changing temperatures. In some applications (e.g., in corrugated-hose applications), conduit 24 may be selectively heated (e.g., via integrated circuits of hot oil) to ensure that asphalt (or other fluids) does not cool, agglomerate, and/or solidify inside the corrugations and/or that the asphalt maintains a desired viscosity. One or both ends of conduit 24 may include a coupling 28 that facilitates quick, yet secure, connections to the corresponding port 18 and/or transfer unit 26. It is contemplated that, in some applications (e.g., high-temperature applications), coupling 28 could include threaded fastening for greater security (e.g., threaded ports, flanges with threaded bolts, etc.), if desired. It is also contemplated that one or both of conduit 24 could be, or could otherwise include, rigid sections rather than flexible, if desired.

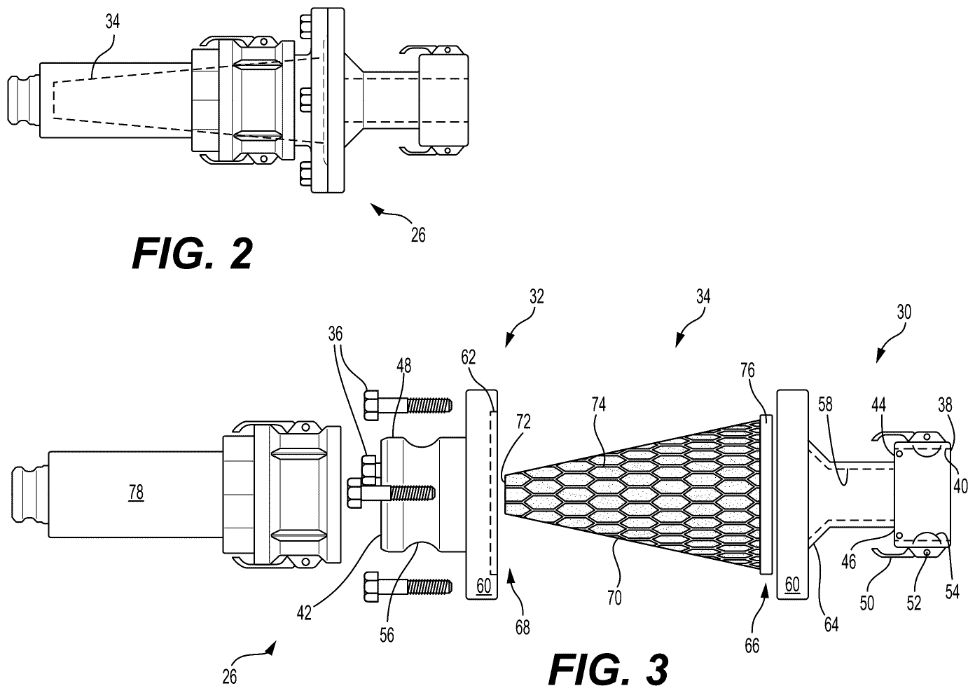

An example transfer unit 26 is shown in detail in FIGS. 2 and 3. As shown in these figures, transfer unit 26 may be an assembly of components that connect between conduits 24 (e.g., via couplings 28), ports 18, and/or pump 22 (referring to FIG. 1) to transfer fluids therebetween, while straining the globs/chunks or other impurities from the fluids during the transfer. These components may include among other things, in inlet fitting 30, an outlet fitting 32, and one or more screens 34. Inlet fitting 30 may engage the upstream/supplying conduit 24, while outlet fitting 32 may engage the downstream/receiving conduit 24. Screen(s) 34 may be sandwiched at least partially between inlet and outlet fittings 30, 32. Any number of fasteners 36 may join inlet fitting 30 to outlet fitting 32.

Inlet and outlet fittings 30, 32 may be configured to complement couplings 28 of the associated conduits 24, pump 22, and/or ports 18. In one embodiment, inlet fitting 30 includes a female portion 38 having an internal cavity 40 configured to receive a mating male protrusion 42 of the complimentary hardware. It should be noted that outlet fitting 32 may be substantially identical to either the male protrusion 42 just introduced or to inlet fitting 30. However, when inlet and outlet fittings 30, 32 are different, it may be easier to visually observe an intended flow direction through unit 26 (e.g., with the female features being located upstream of the male features).

A seal (e.g., an o-ring) 44 may be located against a shoulder 46 inside internal cavity 40 and configured to engage an annular surface 48 of protrusion 42 after insertion. Any number of levers 50 may be pivotally connected (e.g., via pins 52) to an outer periphery of female portion 38 and extend through a wall thereof, such that a cam lobe 54 (only one labeled in FIG. 3—for clarity) located at a base end of each lever 50 (e.g., where pivot pins 52 are also located) engages an annular groove 56 formed in the outer annular surface of protrusion 42 to retain protrusion 42 fully inserted into internal cavity 40 when levers 50 are moved to locked positions. A central flow passage 58 may pass through each of fittings 30, 32. This type of coupling may be known as a cam-and-groove or camlock coupling.

Each of inlet and outlet fittings 30, 32 may include a radially extending flange 60 at an interior end that has a mating face generally perpendicular to a flow direction through passage 58. This face of inlet fitting 30 may be configured to mate against the opposing face of fitting 32, such that the associated male/female features 38, 42 protrude axially outward from flanges 60. Fasteners 36 may pass through corresponding bores (not shown) in flanges 60. In one embodiment, the bores associated with inlet fitting 30 are clearance bores, while the bores associated with outlet fitting 32 are threaded bores. In this configuration, shafts of fasteners 36 may pass through the bores in inlet fitting 30 without interference, and threadingly engage the bores in outlet fitting 32. A reverse configuration is also contemplated. It is also contemplated that all bores in transfer unit 26 may be clearance bores, and separate fastening mechanisms (e.g., locknuts) may engage the threaded ends of fasteners 36. At least one of inlet or outlet fittings 30,32 may include a recessed ring 62 located within the face of the corresponding radial flange 60 and located radially outward of passage 58 and inward of the clearance bores. As will be explained in more detail below, recessed ring 62 may facilitate sealing of inlet/outlet fittings 30, 32 with each other and with screen 34.

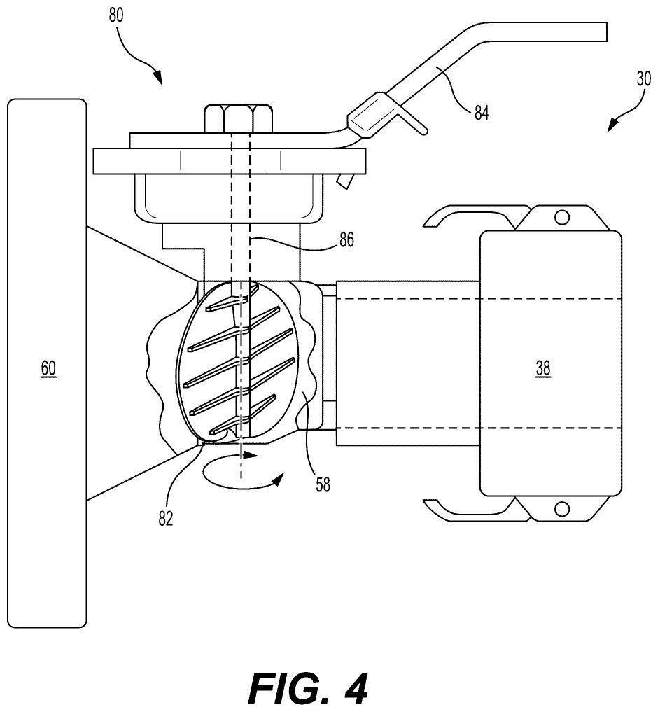

In one embodiment, inlet fitting 30 may include a tapered portion 64 adjacent (e.g., upstream of) flange 60. For example, passage 58 may flare outward as it approaches flange 60, such that an interior cavity at flange 60 has an increasingly larger diameter than a diameter of passage 58. As will be explained in more detail below, this larger interior volume at flange 60 may facilitate assembly of additional components in an alternative embodiment of transfer unit 26 shown in FIG. 4.

Each screen 34 may be generally conical or frustoconical (shown in FIG. 3), having a base end 66 with a larger diameter, and an opposing tip end 68 with a smaller diameter. An axial length of screen 34 may be greater than an axial length of fitting 32, such that tip end 68 extends through and a distance past a downstream end of fitting 32 (see dashed lines in FIG. 2). In one example, about 5% 10%, 20%, 30%, 40%, 50% or more of the overall axial length of screen 34 extends past a distal portion of fitting 32. In this example, tip end 68 may be housed at least partially within conduit 24 (e.g., within coupling 28 or the flexible portion of the downstream conduit 24), allowing transfer unit 26 to be portable (e.g., more compact and lighter weight).

Screen 34 may include an annular wall 70 (and end wall 72, in some applications) having perforations 74 sized and/or shaped for use with particular fluids. For example, in asphalt-transferring applications, the mesh of perforations 74 may have a standard opening size of 6-20 (e.g., 3360-841 μm or 0.132-0.0331 in). In another example, where a latex emulsion is being transferred, the mesh of perforations 74 may have a standard opening size of 10-200 (e.g., 2000-74 μm or 0.0787-0.0029 in). In some embodiments, the mesh of perforations 74 may be purposely undersized (e.g., by 5%, 10%, 20% or more), such that screen 34 clogs more readily. This may provide an indication of a problem associated with the fluid being transferred, at an early enough time for corrective action to be taken.

Base end 66 of screen 34 may include a flange 76 that extends radially outward from annular wall 70. Flange 76 may be made from, coated with, bonded to, or otherwise include a sealing mechanism (e.g., an elastomeric material) and configured to be at least partially received within recess ring 62 of flange 60. In one example, an axial thickness of flange 76 (including the elastomeric material) may be greater than an axial depth of recess ring 62, such that some compression of the elastomeric material is achieved during assembly of transfer unit 26 (e.g., when flanges 60 are bolted together). This compression may function to seal flanges 60 to each other and to screen 34.

In one embodiment, screen 34 is fabricated from a durable and reuseable material that allows for cleaning at high temperatures. For example, screen 34 may be fabricated from aluminum, stainless steel, ceramic, or another similar material that is structurally unaffected during exposure to temperatures high-enough to burn away the fluids, globs, and/or chunks attached to screen 34 after use. In other applications, however, screen 34 may be fabricated from a disposable material and/or a material (e.g., paper, wood, plastic-such as PVC, Nylon, PETG, etc.) that also burns away during cleaning. That is, it may be possible for the entire transfer unit 26 to be placed in an autoclave, furnace or other device (e.g., fully assembled) and for screen 34 to be burned away sufficiently (e.g., completely) to allow for reuse with a new screen. In another application, a handheld torch may be used to burn away the disposable screen 34 and any associated residues. The material of the reusable screen (and the rest of transfer unit 26, in some applications) may have a melting temperature that is 2-7 times higher than a melting temperature of the material used to fabricate the disposable screen.

In some applications, multiple screens 34 may be used together. For example, one screen 34 may be assembled at least partially inside of an adjacent screen 34 (e.g., nested), with flanges 76 pressed against each other or separated by radial spacers (not shown). In these embodiments, screens 34 may have different mesh sizes (e.g., increasingly smaller perforations 74 for further-downstream screens 34, or vice versa). These serially placed screens 34 may allow for extended use times before clogging and/or for trapping and/or sorting of different sized contaminates in the spacing between screens 34. The trapping and sorting of the contaminates may help diagnose issues associated with the fluid being transferred and/or processing of the fluids.

When multiple screens 34 are nested together, the screens 34 may be made of different materials. For example, one or more of the nested screens 34 may be fabricated from a rigid material (e.g., metal, ceramic, plastic, etc.) while one or more of the other nested screens 34 may be flexible (e.g., made a relatively denser sock or more porous netting of paper, burlap, fabric, etc.). In these instances, the rigid screens 34 may be reusable, while the flexible screens may be the disposable components. Use of the flexible screens may allow for finer filtration without significantly increasing a size of transfer unit 26.

In some embodiments, an optional extender 78 may be utilized in conjunction with transfer unit 26. In one example extender 78 may provide extra protection to tip end 68 of strainer 34 that extends through fitting 32. For example, extender 78 may provide a rigid covering for the exposed tip end 68 of strainer 34. In another example, extender 78 may additionally function as a reducer or enlarger-allowing different sizes of couplings 28 and/or ports 18 to be utilized with the same transfer unit 26. For example, transfer unit 26 may be used in conjunction with ports 18 and/or conduits 24 that have diameters of ½″, 1″, 2″, 3″, 4″, 5″, 6″ or more. Extender 78 may have fittings that function similar to those described above.

An alternative embodiment of fitting 30 is illustrated in FIG. 4. As shown in this figure, fitting 30 may include an integrated valve 80. Valve 80 may be located between female portion 38 and flange 60, and moveable to selectively allow, block, or meter fluid through transfer unit 26. Valve 80 may include, among other things, a valve element (“element”) 82 located in the flow of passage 58, an interface 84 located external to fitting 30, and a force transmitter (“transmitter”) 86 extending from interface 84 to element 82.

Element 82 may embody any type of flow-passing/blocking/restricting device known in the art. For example, element 82 may embody a disk, a ball, a plunger, a poppit, a needle, a spool, a plug, or another similar device. Element 82 may be selectively rotated, extended/retracted, translated, expanded/contracted, or otherwise adjusted to move into/out of a flow path of passage 58. This motion may function to increase/decrease an area of the flow path, to open/close the flow path, to create/dismantle the flow path, etc.

Element 82 may be caused to move when a force from interface 84 is applied to element 82 via transmitter 86. In the disclosed embodiment, element 82 is a stem or shaft that extends radially through a wall of fitting 30; and interface 84 is a handle (e.g., a lever, a handwheel, etc.) connected to an external end of element 82. An internal end of transmitter 86 may be rigidly connected to element 82. Force may be directly applied to interface 84 by a human operator or indirectly applied via an actuator (e.g., an electronic actuator, a pneumatic actuator, a hydraulic actuator, a mechanical actuator, etc.—not shown). It is contemplated that additional elements (e.g., bearings, seals, set screws, etc.) may be used to connect these components to each other and/or to fitting 30.

As briefly introduced above, the enlarged cavity at flange 60 may facilitate assembly of element 82 into fitting 30. That is, in one example, element 82 may be larger than a cross-sectional area of passage 58. In this example, to assembly valve 80, element 82 may be passed through the enlargement into alignment with a radial opening in the annular wall of fitting 30. Thereafter, transmitter 84 may be inserted through the radial opening and engaged with element 82, followed by attachment of interface 84 with transmitter 84. Without the enlarged cavity at flange 60, insertion and/or assembly of element 82 may be difficult, if not impossible. As will be explained in more detail below, valve 80 may facilitate cleaner and more controllable fluid transfer events.

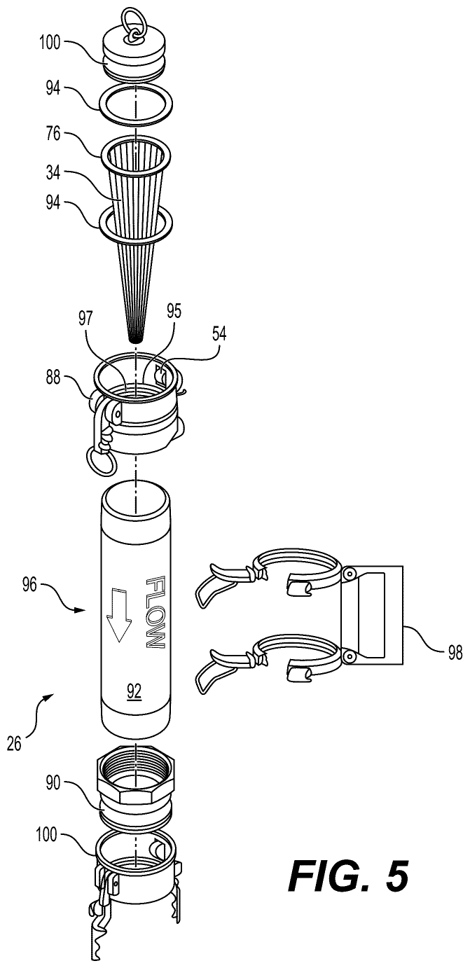

Another embodiment of transfer unit 26 is illustrated in FIG. 5. Similar to transfer unit 26 of FIG. 2, transfer unit 26 of FIG. 5 may include screen 34 located between a female inlet fitting 88 and a male outlet fitting 90 that are each equipped with camlocks. In contrast to the embodiment of FIG. 2, inlet and outlet fittings 88, 90 may not include flanges 60. Instead, inlet and outlet fittings 88, 90 may each threadingly engage opposing ends of a tubular body 92. In addition, screen 34 may not include integral seals, but instead flange 76 of screen 34 may be sandwiched between standalone seals 94.

Screen 34 may be held assembled to inlet fitting 88 in a secure manner to inhibit unintentional disassembly during transport (i.e., before engagement with conduits 24—referring to FIG. 1). In one example, an annular recess 95 may be formed inside of inlet fitting 88 and adjacent an end should 97. An outer diameter of recess 95 may be larger than an inner diameter of inlet fitting 88. Similarly, an outer diameter of seals 94 may be larger than the inner diameter of inlet fitting 88, but smaller than the outer diameter of recess 95. An outer diameter of flange 76 may be smaller than the inner diameter of inlet fitting 88, but larger than an inner diameter of shoulder 97. With this configuration, deformation (e.g., constriction and/or folding) of seals 94 may occur during assembly into inlet fitting 88, after which seals 94 may expand back to their original shapes to fill recess 95. Seals 94 may then be inhibited from existing inlet fitting 88 (e.g., without being deformed again). Accordingly, the last seal 94 assembled into inlet fitting 88 (i.e., on top of flange 76 of screen 34) may retain screen 34 in its assembled position. In addition, the camlocks of inlet fitting 88 may be moved to their locked positions after assembly of screen 34 and during transport, such that their corresponding cam lobes 54 further function to retain screen 34 in place.

Body 92 may be generally cylindrical and hollow, having opposing ends that are threaded to engaged inlet and outlet fittings 88, 90. In one embodiment, markings 96 may be provided on an outer surface of body 92 to specify a flow direction through transfer unit 26. In some applications, the flow direction should be arranged from inlet fitting 88 to outlet fitting 90, such that any fluid passing through transfer unit 26 enters the open end of screen 36 and flows radially outward through the perforated tapered screen wall. This flow direction may generate tension within the screen material (e.g., from base end 66 to tip end 68—referring to FIG. 3), which may reduce a likelihood of crumpling screen 34 that might otherwise be caused by compression forces. This may be more important when screen 34 is fabricated from a disposable material (e.g., plastic) and exposed to elevated temperatures that might otherwise tend to deform screen 34.

In some embodiments, a handle 98 may be affixed to body 92 to aid in carrying transfer unit 26 and assembling conduits 24 (referring to FIG. 1) to fittings 88, 90. In the disclosed embodiment, handle 98 may be removable from body 92 to aid in storage onboard trucks 12, 14. Although depicted as including quick-release clamps to affix handle 98, other methods may also be employed. In addition, it is contemplated that handle 98 could be permanently attached to body 92 (e.g., via welding or integrated fabrication methods such as 3D printing), if desired.

It has been found that, although screen 34 may be made of a disposable material in some applications, the disposable version of screen 34 may still be usable more than once. For example, the disposable version of screen 34 may be usable 2, 3, 5, 10 times or more. In these situations, cleaning between uses may still be necessary and may not be performed in the same manner as the non-disposable (e.g., metallic or ceramic) screens 34. In these situations, it has been found that soaking screen 34 in a solvent (e.g., diesel fuel) between uses may clean screen 34 sufficiently. For this reason, end plugs 100 may be provided for use with transfer unit 26. End plugs 100 may include features complimentary with inlet and outlet fittings 88, 90, such that end plugs 100 can be secured in place using corresponding camlocks. For example, a first end plug 100 may be placed inside of inlet fitting 88 and secured with the integral camlocks of inlet fitting 88, while a second end plug 100 may be placed over outlet fitting 90 and secured via camlocks that are integral to the second end plug.

To clean a disposable-type screen 34, one of the end plugs 100 may be secured to transfer unit 26, body 92 may be at least partially filled with diesel fuel, and the remaining end plug 100 may thereafter be secured. The diesel fuel may act on any impurities trapped in screen 34 between uses, and the diesel fuel may be appropriately disposed of when cleaning is complete.

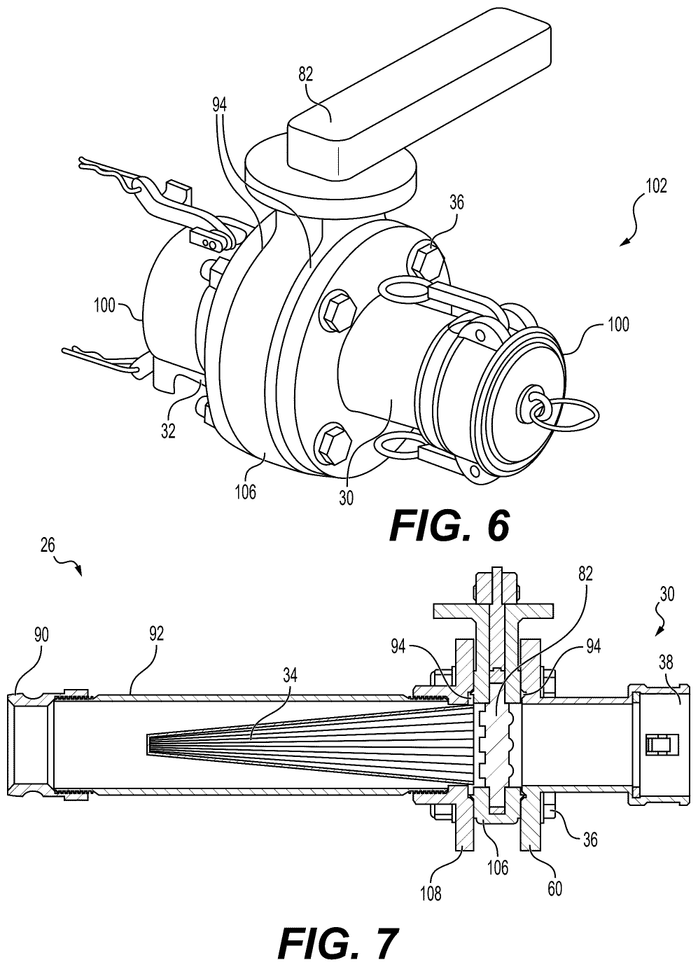

FIG. 6 illustrates a modular valve 102 that may be used in conjunction with transfer unit 26 of FIGS. 1, 2, 3, and/or 5. Because of the modularity of valve 102, valve 102 may be placed upstream and/or downstream of transfer unit 26 within system 10. For example, two valves 102 may be utilized simultaneously and placed at opposing sides of transfer unit 26. This may be helpful to prevent undesired leakage from either or both conduits 24 (referring to FIG. 1) during connection and disconnection from transfer unit 26.

As shown in FIG. 6, valve 102 may include, among other things, inlet and outlet fittings 30, 32 from transfer unit 26 illustrated in FIG. 3. However, in this embodiment, screen 34 may be omitted. In place of screen 34, valve element 82 (referring to FIG. 4) or another similar valve mechanism may be assembled inside a standalone body 106 and mounted between flanges 60 (e.g., via fasteners 38). Seals 94 from the embodiment of FIG. 5 (or other similar sealing mechanisms) may be used together with valve body 106 (e.g., one adjacent each end face of flanges 60), if desired. End caps 100 may likewise be used together with valve 102, if desired.

FIG. 7 illustrates another example of transfer unit 26. As shown in FIG. 7, this embodiment may be a combination of the transfer unit 26 disclosed in FIG. 5 and valve 102 disclosed in FIG. 6. For example, transfer unit 26 of FIG. 7 may include inlet fitting 30 located at a first end (i.e., at the right-hand end in the perspective of FIG. 7) and outlet fitting 90 mounted to body 92 at an opposing second end (i.e., at the left-hand end). A threaded flange 108 may engage the end of body 92 opposite outlet fitting 90, and valve body 106 (and corresponding valve element 82) together with screen 34 may be sandwiched between flange 108 and flange 60 of inlet fitting 30. Seals 94 may be located at either side of body 106.

In the configuration of FIG. 7, valve element 82 may be located completely outside the mouth of screen 34 when in the closed orientation. In contrast, valve element 82 may pivot into the mouth of screen 34 due to the compact arrangement of transfer unit 26.

Screen 34 has been described throughout this disclosure as a standalone component that may be selectively removed from the rest of transfer unit 26 for cleaning and/or discard. In some instances, screen 34 is disclosed as being fabricated from a metallic or ceramic material and intended for many uses and high-temperature cleaning. In other instances, screen 34 is disclosed as being fabricated from a less durable and/or less expensive material and meant to be disposed of (e.g., via high-temperature exposure) after fewer uses. As a standalone component, screen 34, regardless of being disposable or not, may be used together with other long-life (e.g., metal or ceramic) components (e.g., fittings, couplings, valves, bodies, etc.).

It is contemplated, however, that some or all of the other components of transfer unit 26 may likewise be made of a non-metallic or non-ceramic material. For example, fittings 30, 32; fittings 88, 90; body 92; valve element 82; valve body 106; and/or other components of transfer unit 26 may be fabricated from a plastic material (e.g., via 3D printing, injection molding, etc.). In these instances, it is contemplated that some or all of these components may be integrated and fabricated together as a monolithic component, if desired. For example, screen 34 could be printed together with inlet fitting 30, outlet fitting 32, and/or body 96. A transfer unit 26 made after this manner may be lighter and function adequately for lower-temperature applications (e.g., for emulsions having temperatures less than about 200° C.) with anticipated longevity.

### INDUSTRIAL APPLICABILITY

The disclosed fluid transfer system, unit, and methods may improve the transfer of road construction fluids between two locations. For example, the disclosed system, unit, and methods may increase a quality of the transferred fluids by remove undesirable contaminates from the fluid. The disclosed system, unit, and methods may also increase a cleanliness of a worksite and reduce waste by decreasing spillage of the fluids. The disclosed system and unit may also be lighter and more mobile than conventional equipment, thereby decreasing a physical impact on the operator, a likelihood of use, and/or a time required to complete the fluid transfer. Operation of system 10 will be discussed in detail, with reference to FIGS. 1-7.

As shown in FIG. 1, an exemplary fluid transfer event may begin once tanker truck 12 (or another supply tank 16) has been located sufficiently close to distributor truck 14 (or another receiving tank 16). An operator may then connect the upstream coupling 28 of an associated supply conduit 24 to the outlet port 18 of tanker truck 12 and connect the downstream coupling 28 of an associated receiving conduit 24 to the outlet port 18 or pump 22 of distributor truck 14.

Transfer unit 26, having one or more screens 34 already assembled therein, may then be connected between the free couplings 28 of the two conduits 24. For example, fitting 30 may be connected to the downstream coupling 28 of the supply conduit 24, and fitting 32 may be connected to the upstream coupling 28 of the receiving conduit 24. Once all couplings 28 are secured, valve(s) 20 of tanker truck 12 and/or distributor truck 14 may be opened by the operator. Fluid may then flow from tank 16 of truck 12 at least to transfer unit 26. Using the transfer unit 26 of FIGS. 2 and 3, the fluid may continue to flow through transfer unit 26 into tank 16 of truck 14. However, when using the transfer unit 26 of FIG. 4, assuming valve element 82 is in the closed position during initial setup, fluid may be inhibited from passing through transfer unit 26 to truck 14 until after valve 80 is opened by the operator.

As described above, in some applications, distributor truck 14 may need to be filled multiple times before completion of a road constructing activity. In these situations, after tank 16 of distributor truck 14 has been filled a first time, valve 80 may be closed by the operator. In this situation, valve 20 associated with tanker truck 14 may remain open or be closed, as desired. Valve 20 associated with distributor truck 12 (if so equipped) may remain open for a period of time after the closing of valve 80, and pump 22 may remain active (if so equipped). This may allow for the supply conduit 24 to remain full of fluid without leakage, and for the receiving conduit 24 to be substantially drained of fluid.

After the receiving conduit 24 has been drained, the valve 20 associated with the distributor truck 14 may be closed and pump 22 may be deactivated. This may allow for disconnection of distributor truck 14 from fluid transfer unit 26 (e.g., via disconnection of the receiving conduit 24 at one or both ends) without spillage of fluid previously contained in the receiving conduit 24. Sometime thereafter, distributor truck 14 may reconnect to fluid transfer unit 26 for refill. During refill, only the closed valve(s) 20, 80 may need to be opened and pump 22 reactivated. Because valve 20 of tanker truck 14 and the supplying conduit 24 may remain full of fluid between refill events, the events may take less time and effort to complete. The events may also be environmentally friendly due to a reduction in spillage between events.

Transfer unit 26 may need to be periodically cleaned and/or fitted with different/replacement screen(s) 34. While, in one embodiment, transfer unit 26 may be disposable in its entirety—in other embodiments, only screens 34 may be disposable. In these latter embodiments, fasteners 36 (referring to FIG. 3) may be selectively removed to allow separation of flanges 60 from each other. Screen(s) 34 may then be pushed (e.g., from the exposed tip end 68) and/or pulled out of fitting 30 and placed within an autoclave for pyrolyzing of the unwanted materials. The ability to push screen(s) 34 out of fitting 30 may make the remove easier and quicker, with less damage to the screens. It is contemplated that screens 34 may be cleaned in situ (without removal from transfer unit 26), if desired.

It will be apparent to those skilled in the art that various modifications and variations can be made to the disclosed system, unit, and methods. Other embodiments will be apparent to those skilled in the art from consideration of the specification and practice of the disclosed system, unit, and methods. For example, while the disclosed system, unit, and methods may find particular application and provide particular benefits within the road construction industry, they may also be used successfully to transfer other fluids not associated with road construction. In another example, although the fluid transfer unit is disclosed as having an upstream/inlet end and a downstream/outlet end, it is contemplated that these relationships and corresponding hardware could be reversed, if desired (e.g., the upstream/inlet end could have male geometry, while the downstream/outlet end could have female geometry). It is also contemplated that locations of screen 34 and/or valve 80 could be reversed (e.g., screen 34 could be located within inlet 30 and pointed upstream and/or valve 80 could be located within outlet 32). Other configurations are also considered. It is intended that the specification and examples be considered as exemplary only, with a true scope being indicated by the following claims and their equivalents.

What is claimed is:

1. A fluid transfer unit, comprising:
a body having a first end and an opposing second end;
an inlet fitting connected to the first end of the body;
an outlet fitting connected to the second end of the body;
a screen disposed inside the body between the inlet and outlet fittings; and
at least one seal disposed at an end of the screen and configured to retain the screen at a desired location inside the body during transportation of the fluid transfer unit.

2. The fluid transfer unit of claim 1, wherein:
the body is generally cylindrical; and
the screen is conical or frustoconical.

3. The fluid transfer unit of claim 1, wherein:
the body includes markings on an outer surface indicating a flow direction through the body; and
the flow direction extends through an open base end of the screen radially outward through a tapered surface.

4. The fluid transfer unit of claim 1, wherein the body has a melting temperature about 2-7 times a melting temperature of the screen.

5. The fluid transfer unit of claim 4, wherein both the body and the screen are corrosion resistant to diesel fuel.

6. The fluid transfer unit of claim 1, further including:
a first plug configured to seal off the inlet fitting; and
a second plug configured to seal off the outlet fitting.

7. The fluid transfer unit of claim 1, wherein the body, the inlet fitting, the outlet fitting, and the screen are plastic.

8. The fluid transfer unit of claim 1, wherein the body, the inlet fitting, the outlet fitting, and the screen are manufactured as a single monolithic component.

9. The fluid transfer unit of claim 1, further including a carrying handle removably attached to the body.

10. The fluid transfer unit of claim 1, further including a valve configured to regulate flow through the body.

11. The fluid transfer unit of claim 10, wherein the valve is located between the inlet fitting and the outlet fitting.

12. The fluid transfer unit of claim 1, wherein the seal is received within an annular groove in the inlet fitting.

13. The fluid transfer unit of claim 1, wherein each of the inlet and outlet fittings includes at least one camlock for attachment to a conduit.

14. A fluid transfer unit, comprising:
a generally cylindrical body having a first end and an opposing second end;
an inlet fitting connected to the first end of the cylindrical body;
an outlet fitting connected to the second end of the cylindrical body; and
a conical or frustoconical screen disposed inside the cylindrical body.

15. The fluid transfer unit of claim 14, wherein:
the cylindrical body includes markings on an outer surface indicating a flow direction through the cylindrical body; and
the flow direction extends through an open base end of the conical or frustoconical screen radially outward through a tapered surface.

16. The fluid transfer unit of claim 14, wherein:
the inlet fitting is fabricated from metal;
the outlet fitting is fabricated from metal; and
the conical or frustoconical screen is fabricated from a non-metallic material that burns away when the fluid transfer unit is exposed to elevated temperatures during cleaning.

17. The fluid transfer unit of claim 14, further including a valve located between the inlet fitting and the outlet fitting and configured to regulate flow through the cylindrical body.

18. A fluid transfer system, comprising:
a body having a first end and an opposing second end;
an inlet fitting connected to the first end of the body;
an outlet fitting connected to the second end of the body;
a disposable screen locatable inside the body between the inlet and outlet fittings; and
a reusable screen interchangeable with the disposable screen,
wherein:
the disposable screen has perforations with a standard opening size of 6-20; and
the reusable screen has perforations with a standard opening size of 10-200.

19. The fluid transfer system of claim 18, wherein:
the disposable screen is plastic; and
the reusable screen is metallic.

20. The fluid transfer system of claim 18, further including a modular valve having:
a first fitting engageable with the inlet fitting; and
a second fitting engageable with the outlet fitting.
